(19) United States
(12) Patent Application Publication
(10) Pub. No.: US 2022/0178096 A1
(43) Pub. Date: Jun. 9, 2022

(54) VEHICLE CONE PLACER AND CHOCK ASSEMBLY

(71) Applicant: ALAN FERNANDO CALDERON, SAN DIEGO, CA (US)

(72) Inventor: ALAN FERNANDO CALDERON, SAN DIEGO, CA (US)

(21) Appl. No.: 17/492,636

(22) Filed: Oct. 3, 2021

Related U.S. Application Data
(60) Provisional application No. 63/065,654, filed on Aug. 14, 2020.

(51) Int. Cl. E01F 9/70; B60Q 7/02; B60T 1/04; E01F 9/654; E01F 9/615; G08B 5/00; G08B 5/36

(52) U.S. Cl. CPC E01F 9/70; B60Q 7/02; B60T 1/04; G08B 5/36; E01F 9/615; G08B 5/006; E01F 9/654

(57) ABSTRACT

Described herein is a vehicle cone placer and chock assembly. The vehicle cone placer is equipped with collapsible traffic cones, a motorized linear actuator, and may have LED safety lights. The vehicle cone placer is telescopic, remote controlled, and mountable to a vehicle. The vehicle cone placer and chock assembly includes at least two chock systems and adjustable brackets hydraulically operated and with at least one motorized assembly. The vehicle cone placer and chock assembly is remotely operated and self-contained as components of the vehicle.

### CLAIM OF PRIORITY

This application claims priority to and the benefit of U.S. Provisional Application with Ser. No. 63/065,654, filed on Aug. 14, 2020, and having the same title, the contents of which are hereby incorporated by reference in its entirety.

### FIELD OF THE INVENTION

The inventive concept relates generally to a vehicle cone placer and chock assembly.

### BACKGROUND

Currently, the common solution for placing traffic cones and placing tire chocks is to place traffic cones and tire chocks manually, but this solution fails to meet the needs of the market because placement is time consuming and can be dangerous. Other solutions for visibility attempt to provide road signals such as flares, which quickly burn out, and reflective triangles which may be less visible than cones. Another solution is to use a vehicle's flashers and brakes, but these solutions may, respectively, be difficult to see and provide added risk of failure particularly for hills or other areas where brakes could fail. Therefore, there currently exists a need in the market for an apparatus and system that addresses the above shortcomings in current product offerings.

### SUMMARY OF THE INVENTION

There currently exists a need in the market for an apparatus that places traffic cones on the road and around a vehicle and secures tires with innovative chocks that will be deployed automatically from the comfort of the cab. Safety is one of the priorities in the transportation industry, companies rely on this metric in order to operate with efficiency while avoiding accidents and injuries; the cone and chock systems mentioned here will drastically improve these aspects of any company and its fleet by saving time and energy of every user that had to place these devices manually in the past and also diminish the risk of getting injured by traffic or the environment outside the vehicle. The product solves many obstacles seen in the transportation industry and provides an innovative and unique solution that will benefit any company and also the civilians that interact directly with vehicles that will use these devices. The inventive concept described herein includes a system for remotely placing visual traffic safety apparatuses from a vehicle that has at least one collapsible cone assembly designed to be in an extended, vertical, and substantially frustoconical form or a collapsed and substantially planar form. At least one retractable, telescoping rod assembly is disposed at least partially within at least one housing assembly, the housing assembly disposed substantially beneath a vehicle, the telescoping rod assembly designed to be in an extended or retracted state. At least one foldable, substantially planer, platform assembly is coupled to a distal end of the at least one telescoping rod assembly designed to be in an unfolded, substantially horizontal state or a folded, substantially vertical state. At least one collapsible cone assembly is coupled to the platform assembly at, when the platform assembly is viewed in an unfolded state, a top portion of the platform assembly. At least one rod motor assembly is electrically coupled to a rod actuator designed to extend and retract the rod assembly. At least one platform motor assembly is electrically coupled to a platform actuator designed to fold and unfold the at least one platform assembly. At least one cone motor assembly is electrically coupled to a cone actuator and designed to extend or collapse the at least one cone assembly. At least one controller assembly is electronically coupled to the at least one rod, platform, and cone actuator assemblies designed for a user to operate the at least one rod, platform, and cone motor assemblies.

In one embodiment of the system for remotely placing visual traffic safety apparatuses, the at least one platform assembly is also a housing assembly with a base portion, a side portion, and an open top portion when the platform assembly is in an unfolded and horizontal state. The collapsible cone assembly is disposed substantially within the housing assembly when the collapsible cone assembly is in a collapsed state.

In one embodiment of the system for remotely placing visual traffic safety apparatuses, an LED light assembly is disposed on a top or center portion of the cone assembly when the cone assembly is respectively in an extended or retracted state.

At least one embodiment includes a tire locking system that has at least one chock assembly, the chock assembly having at least one substantially curved front face, the at least one front face designed to substantially contiguously and frictionally couple to a treaded surface of at least one vehicle tire member, the chock assembly designed to be in a coupled or uncouple state. At least one hydraulically operated frame assembly is designed to be in a retracted or extended state. At least one hydraulically operated extender assembly is connected by a proximal portion of the at least one extender assembly to a distal portion of the at least one frame assembly. A distal portion of the at least one extender assembly is coupled to a back face of the at least one chock assembly, the at least one extender assembly designed, when in an extended state, to press the at least one front face of the at least one chock assembly against the treaded surface of the at least one tire member. At least one actuator assembly is electronically coupled to the at least one frame assembly and the at least one extender assembly. At least one controller assembly is electronically coupled to the at least one chock actuator assembly and at least one chock motor assembly and designed for a user to control the at least one frame assembly and the at least one extender assembly.

In one embodiment of the tire locking system, at least one polymer surface assembly is coupled contiguously and substantially planarly to the at least one front face of the chock assembly adapted to couple substantially contiguously to the treaded surface of at least one vehicle tire member.

It would be advantageous to have a collapsible cone assembly and chock assembly that is mountable. Furthermore, it would also be advantageous to have a collapsible cone assembly and chock assembly that is remote controlled. Still further, it would be advantageous to have a collapsible cone assembly that is telescopic.

The collapsible cone assembly advantageously fills the aforementioned deficiencies by providing a vehicle cone placer, which provides an automatic way to place traffic cones. The collapsible cone assembly may have a remote control and may have telescoping arms.

Among other things, it is an advantage of the collapsible cone assembly to provide a vehicle cone holder that does not suffer from problems or deficiencies associated with prior solutions. It is still further an advantage of the collapsible cone assembly and chock assembly to be hydraulic. Still further, the collapsible cone assembly and chock assembly may have two chocking systems. The inventive concept can also be described as a unique and innovative mechanism that operates at least one automatic set of cones and at least one automatic set of chocks deployed from a control inside the cab, these set of products will improve the industry of transportation by reducing truck rollovers, driver accidents in traffic, efficiency of the driver and time saved when performing daily tasks.

The inventive concept now will be described more fully hereinafter with reference to the accompanying drawings, which are intended to be read in conjunction with both this summary, the detailed description and any preferred and/or particular embodiments specifically discussed or otherwise disclosed. This inventive concept may, however, be embodied in many different forms and should not be construed as limited to the embodiments set forth herein; rather, these embodiments are provided by way of illustration only and so that this disclosure will be thorough, complete and will fully convey the full scope of the inventive concept to those skilled in the art.

### BRIEF DESCRIPTION OF THE DRAWINGS

FIG. 1 illustrates the bottom of the traffic safety cone assembly.

FIG. 2 illustrates the front disengaged or retracted view of the cone assembly.

FIG. 3 illustrates the front of the cone assembly.

FIG. 4 illustrates the perspective disengaged or retracted view of the collapsible cone assembly.

FIG. 5 illustrates the perspective view of the collapsible cone assembly.

FIG. 6 illustrates the side disengaged view of the collapsible cone assembly.

FIG. 7 illustrates the side view of the collapsible cone assembly.

FIG. 8 illustrates the top view of the collapsible cone assembly.

FIG. 9 illustrates the back of the dual tire chock system.

FIG. 10 illustrates the front disengaged view of the dual tire chock system.

FIG. 11 illustrates the front of the dual tire chock system.

FIG. 12 illustrates the perspective disengaged dual tire chock system.

FIG. 13 illustrates the perspective view of the dual tire chock system.

FIG. 14 illustrates the side disengaged view of the dual tire chock system.

FIG. 15 illustrates the side view of the dual tire chock system.

FIG. 16 illustrates the top of the dual tire chock system.

FIG. 17 illustrates the back of the single tire chock system.

FIG. 18 illustrates the front disengaged view of the single tire chock system.

FIG. 19 illustrates the front view of the single tire chock system.

FIG. 20 illustrates the perspective disengaged view of the single tire chock system.

FIG. 21 illustrates the perspective view of the single tire chock system.

FIG. 22 illustrates the side disengaged view of the single tire chock system.

FIG. 23 illustrates the left side of the single tire chock system.

FIG. 24 illustrates the right side of the single tire chock system.

FIG. 25 illustrates the top of the single tire chock system.

FIG. 26 illustrates the cone placer system controller.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

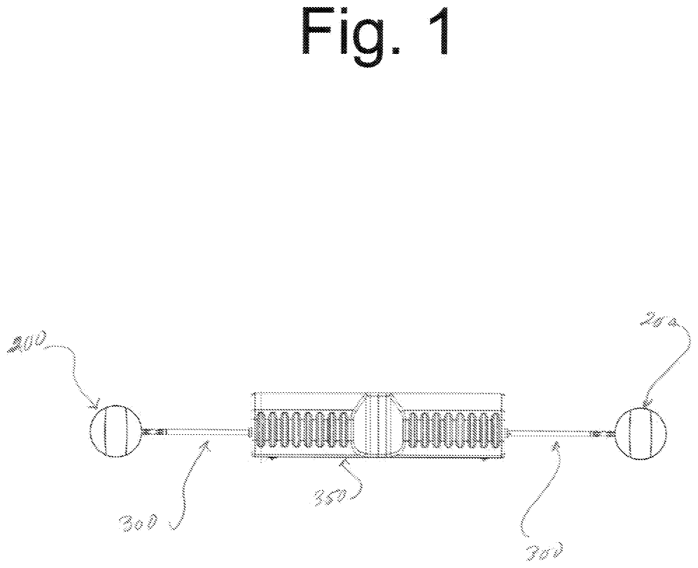

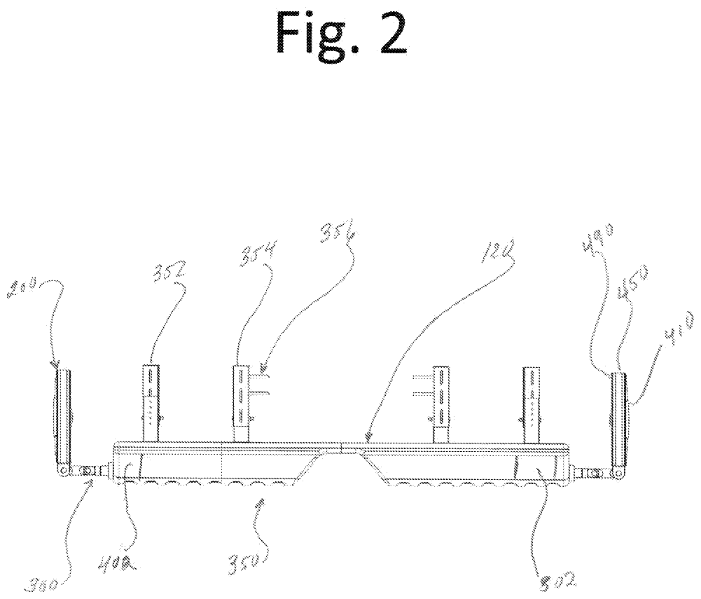

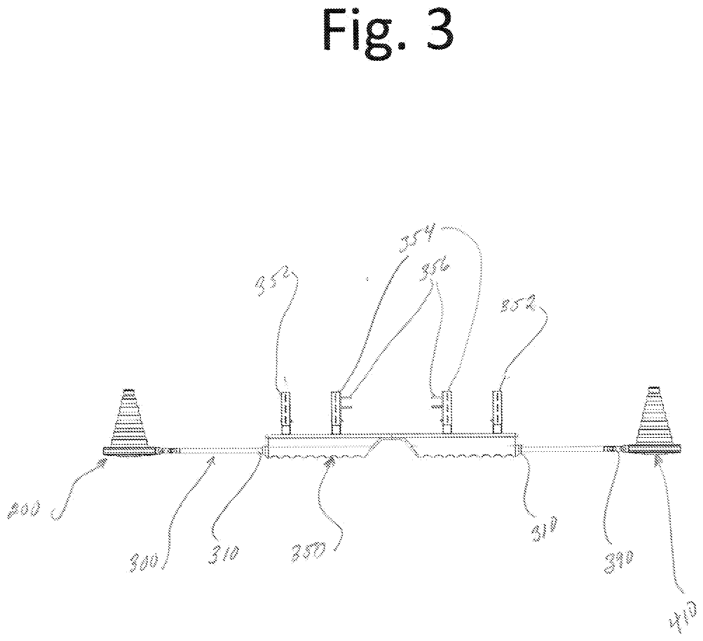

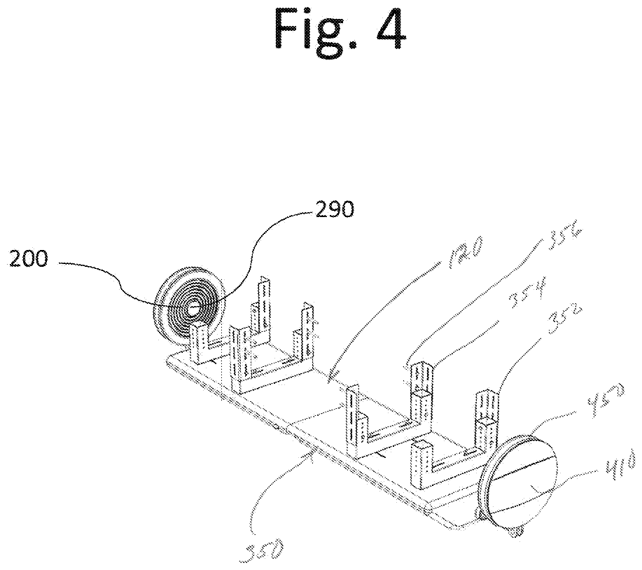

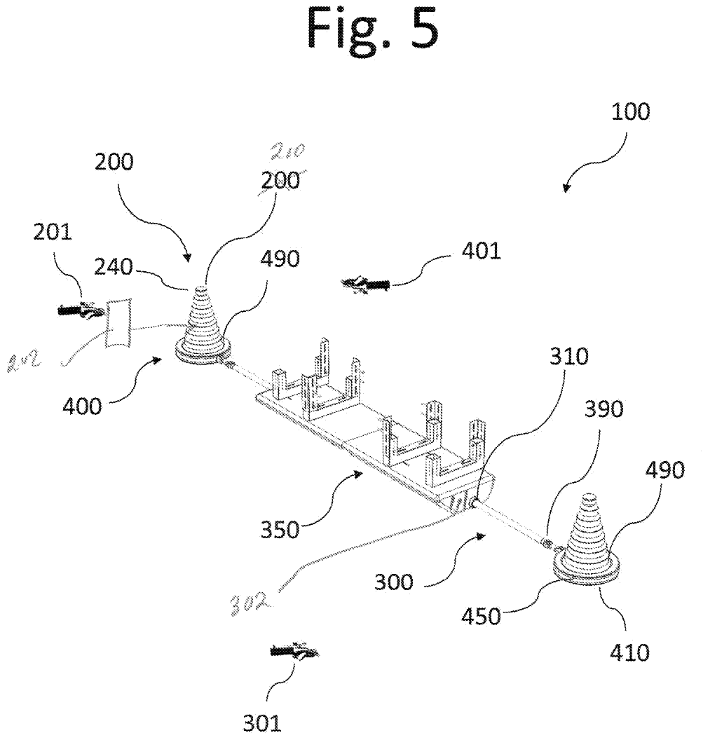

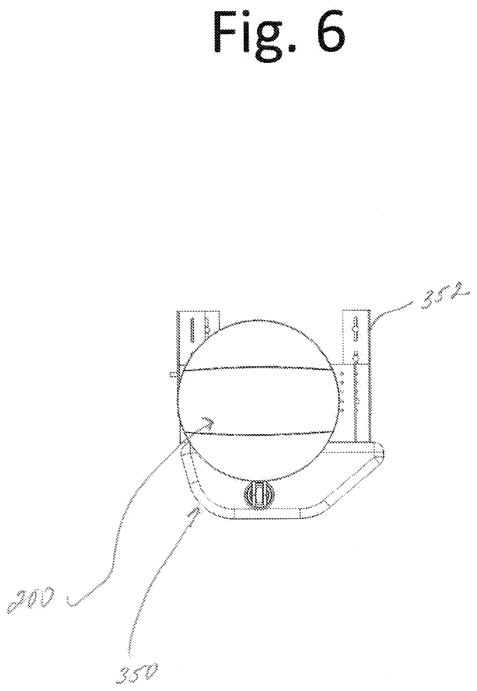

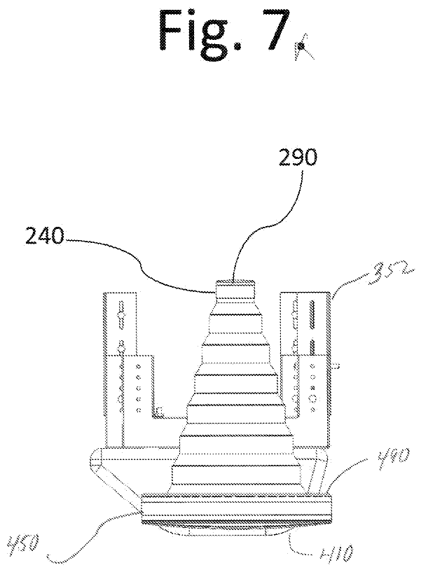

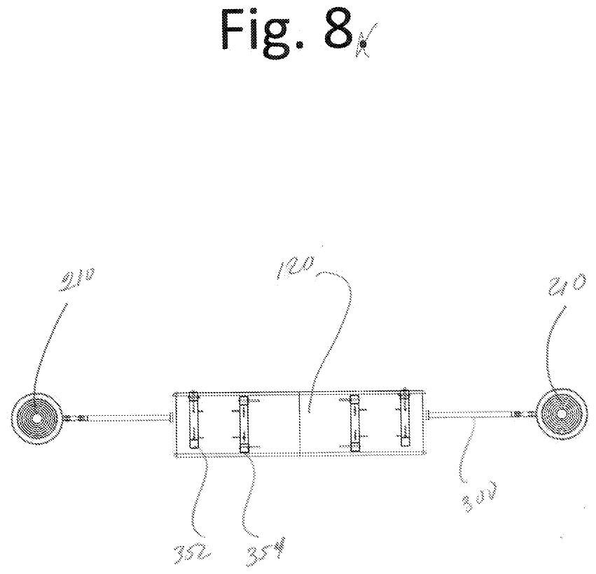

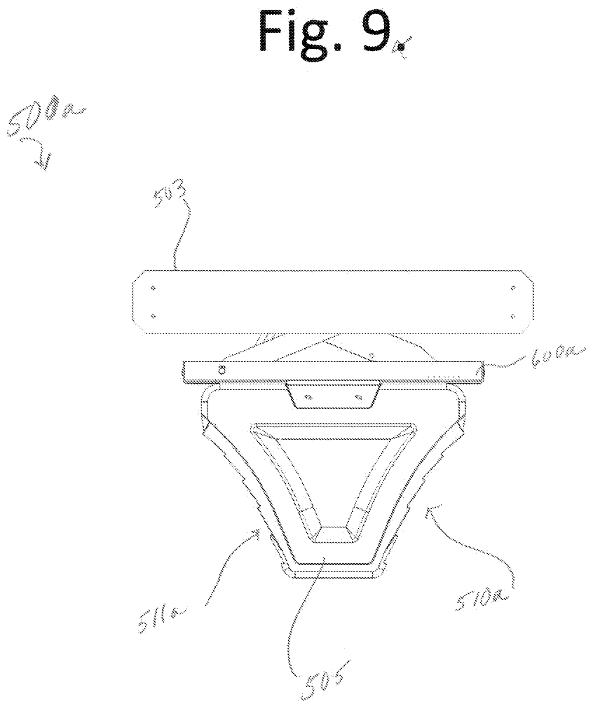

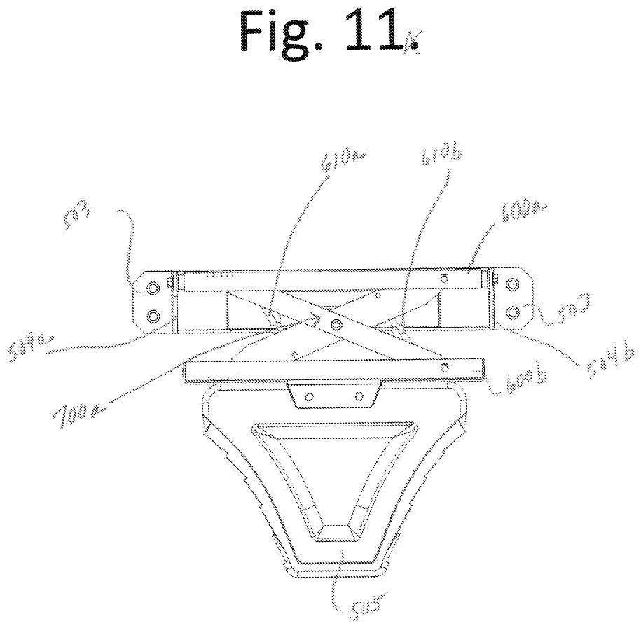

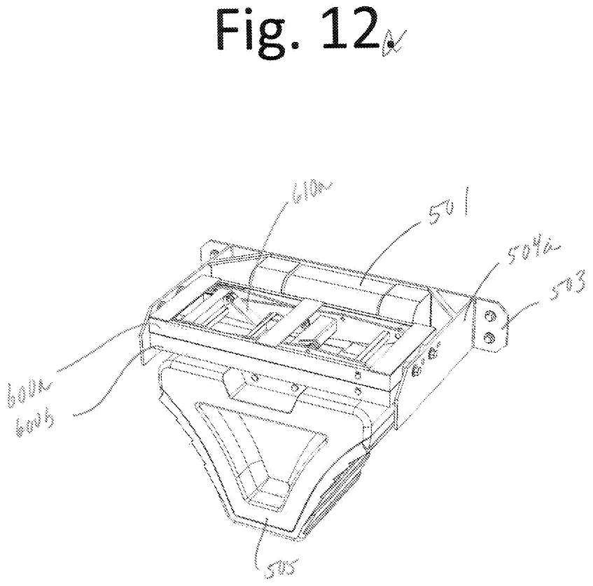

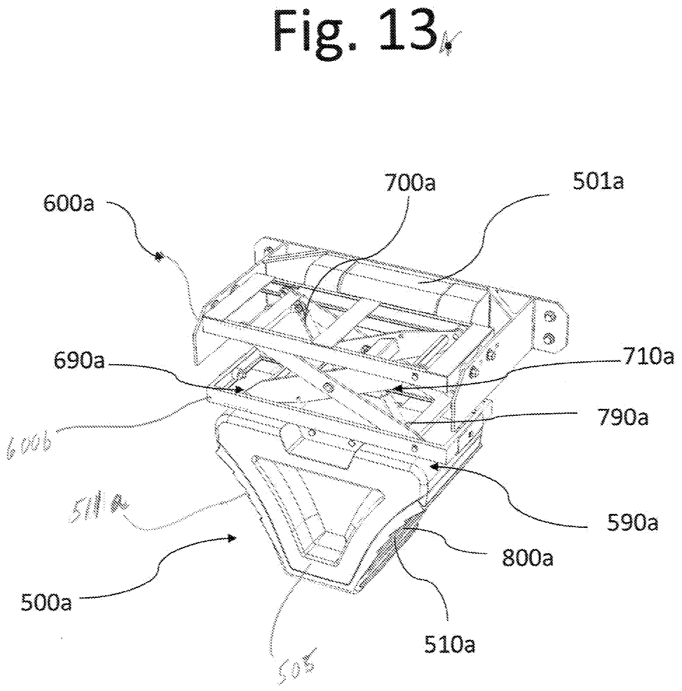

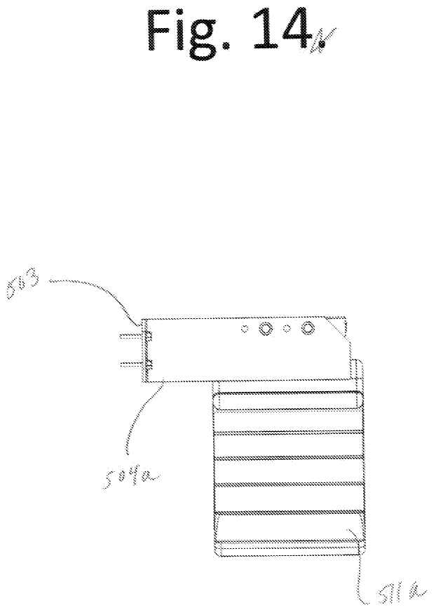

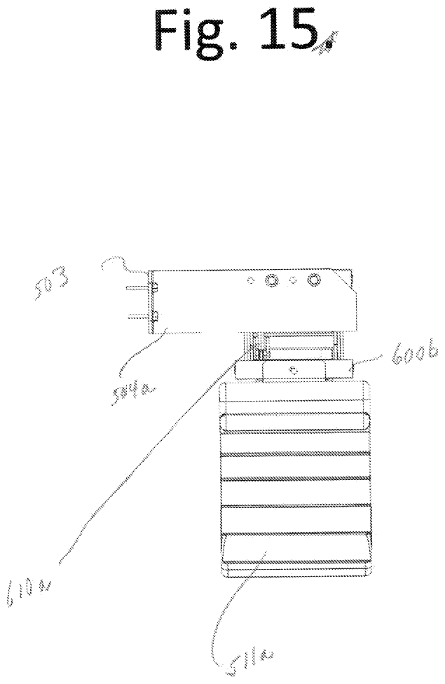

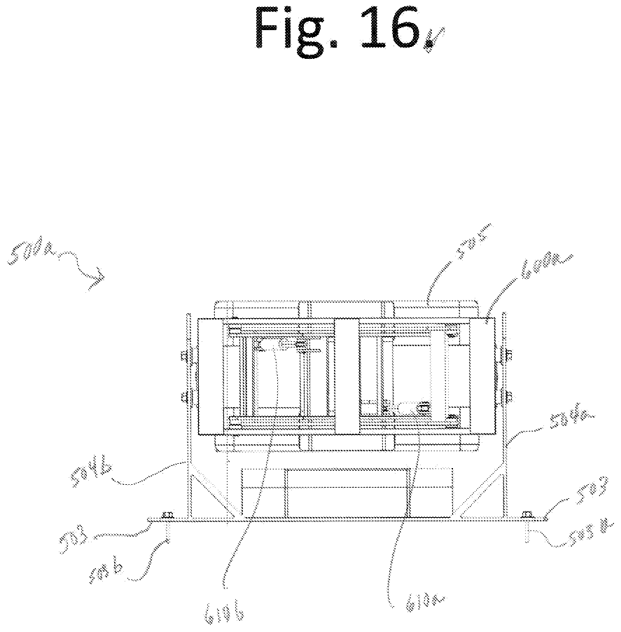

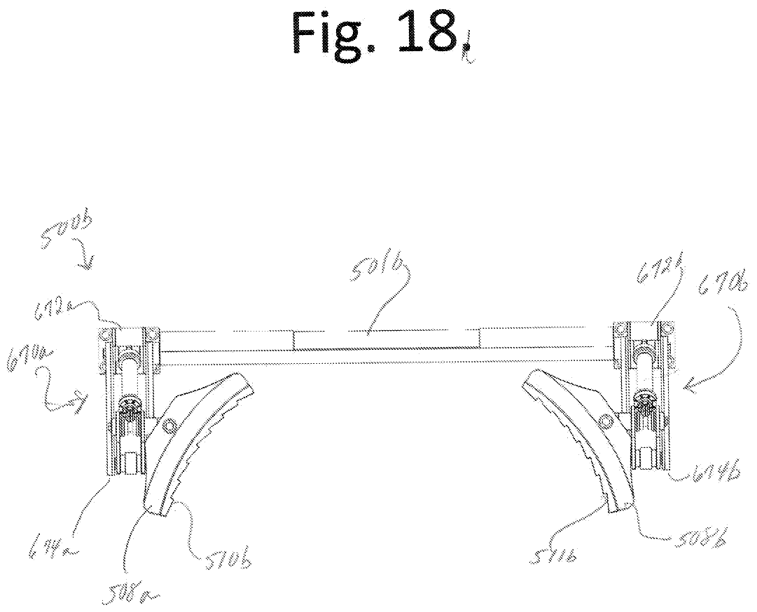

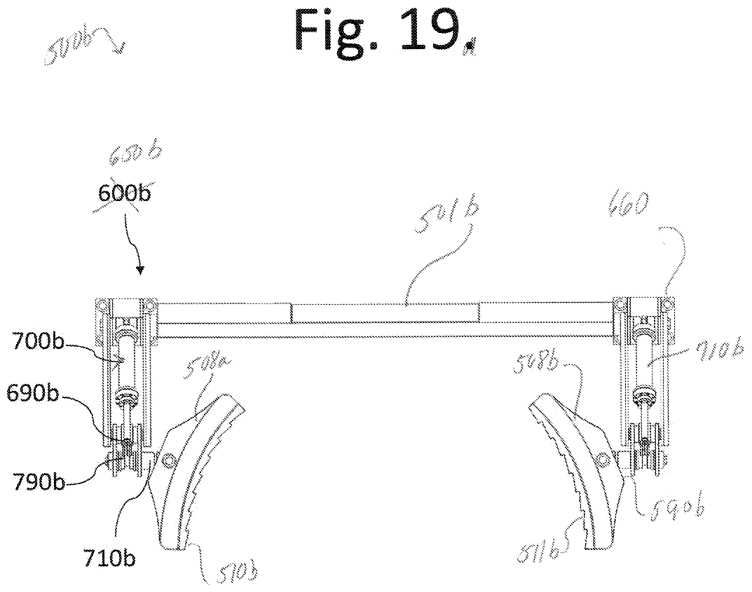

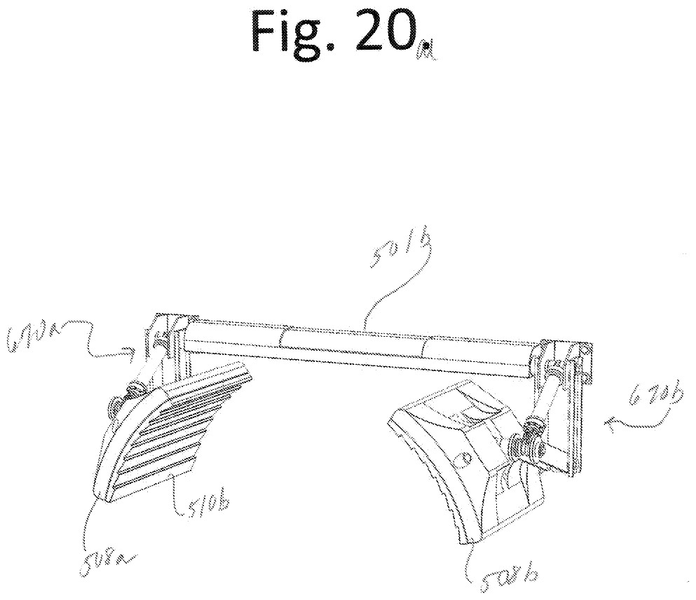

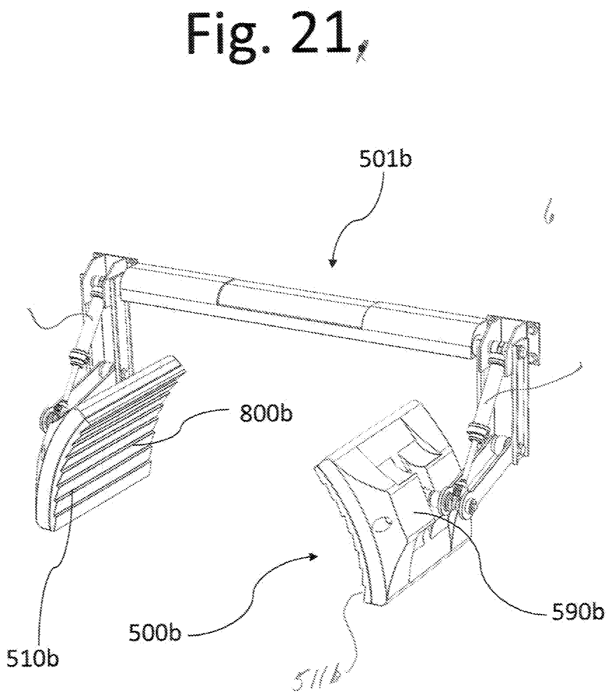

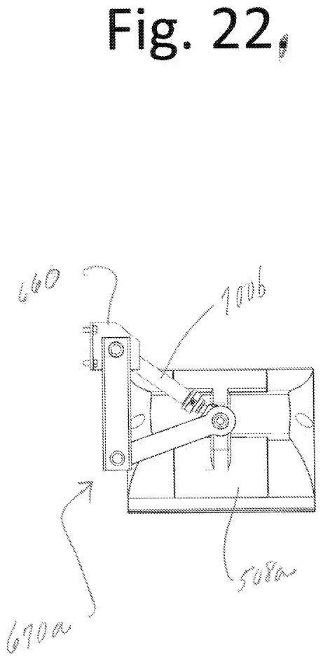

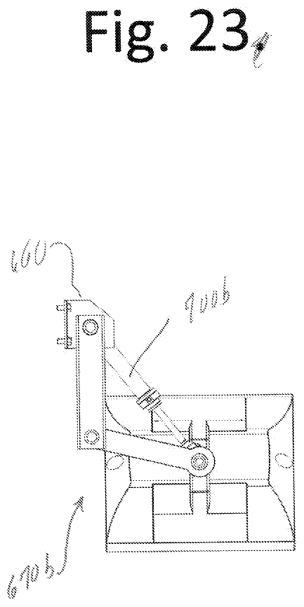

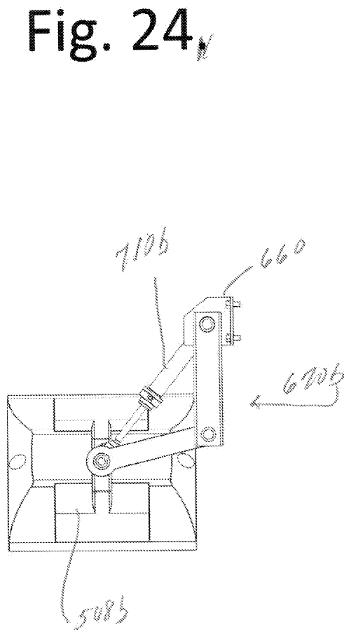

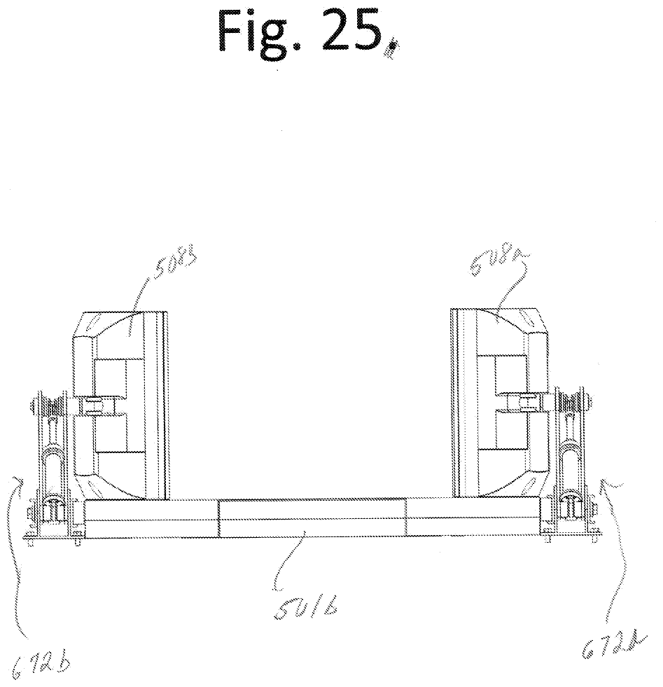

Referring to the figures, in particular FIGS. 1-8, 26, and then FIGS. 9-25, there is illustrated a system 100 for remotely placing visual traffic safety apparatuses from a vehicle 10 (not shown) and for affixing that vehicle in a stationary position should an emergency brake or the transmission fail. System 100 includes a housing assembly 350 and traffic safety cone assembly 200 supported on a support frame 120 and configured to be attached to a front or back (or both) of the vehicle. System 100 also includes a chock system 500 mounted on the vehicle for securing the vehicle from moving (see FIGS. 9-25). In one example embodiment, chock system 500 can include both an inside dual chock tire system 500a and an outside chock assembly 500b having a configuration similar to two outside semi-circular brake pads that come in contact with the outer perimeter of the tire(s) to secure the tires stationary. In a related example embodiment, and to keep system costs down, a rear of the vehicle includes the dual chock system 500a to hold two wheels stationary until they are released. In yet another embodiment, chock system 500 includes chock system 500c which is a single outside or external semi-circular pad that comes down on the top of the outside surface of the tire or wheel to be held stationary.

Referring again to FIGS. 1-8, part of system 100 includes housing assembly 350 with has at least one collapsible cone assembly 200 which includes a cone 210 with the assembly designed to be in an extended, with the cone vertical, and in a substantially frustoconical form or in a collapsed and substantially planar form when it is in a retracted or mobile state. At least one retractable, telescoping rod assembly 300 is disposed at least partially within housing assembly 350 at a proximal end 310 of the telescoping rod assembly 300, with the housing assembly 350 being disposed substantially beneath the vehicle, the telescoping rod assembly 300 designed to be in an extended (when in use) or a retracted state (when the vehicle is mobile). In this example embodiment, housing assembly 350 includes brackets 352 and 354 located on support frame 120 to house or encase cone 210 while the vehicle is in motion. Flanges 356 located on any one of brackets 352 and 354 serve to secure housing assembly 350 to the underside of the vehicle. In a related embodiment, housing assembly 350 and cone assembly 200 is located in the front above or about the hood and/or the rear of the vehicle.

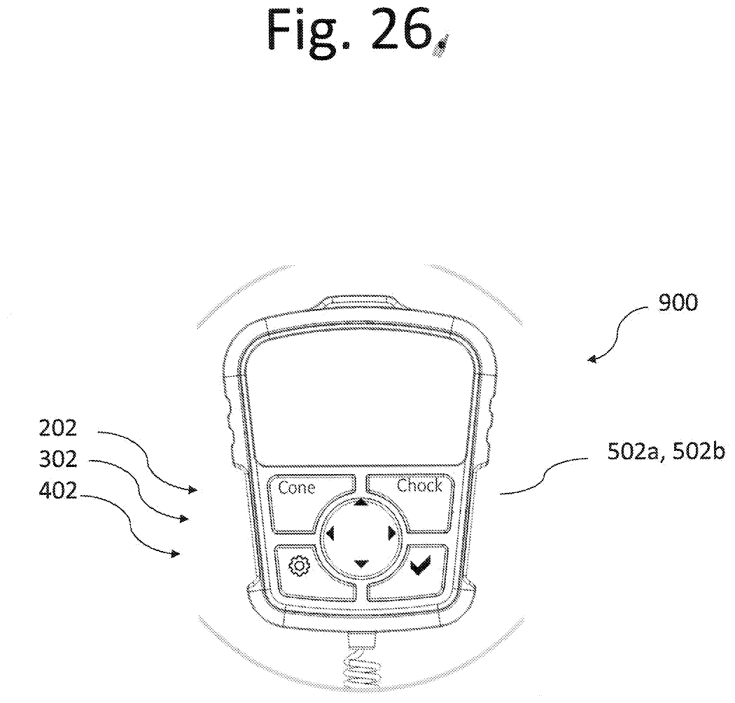

At least one foldable, substantially planar, platform assembly 400 is coupled to a distal end 390 of the at least one telescoping rod assembly 300 designed to be in an unfolded, substantially horizontal state or a folded, substantially vertical state. At least one collapsible cone assembly 200 and cone 210 is coupled to the platform assembly 400 at, when the platform assembly 400 is viewed in an unfolded state, a top portion 490 of the platform assembly 400. At least one rod motor assembly 301 is electrically or electromechanically coupled to a rod actuator 302 designed to extend and retract the rod assembly 300. At least one platform motor assembly 401 is electrically coupled to a platform actuator 402 designed to fold and unfold the at least one platform assembly 400. At least one cone motor assembly 201 is electrically or electromechanically coupled to a cone actuator 202 configured to be inside cone 210 and designed to extend or collapse the at least one cone assembly 200 and cone 210. Referring to FIG. 26, at least one controller assembly 900 (which is designed to be in the vehicle cabin or to be portable and wired or wireless) is electronically coupled to the at least one rod, platform, and cone actuator assemblies 302, 402, 202 designed for a user to operate the at least one rod, platform, and cone motor assemblies 302, 402, 202.

In this embodiment of the system 10 for remotely placing visual traffic safety apparatuses and locationally affixing a vehicle, the at least one platform assembly 400 is also attached to housing assembly 350 and includes a base plate portion 410, a side portion 450 and an open top portion 490 when the platform assembly 400 is in an unfolded and horizontal state. The collapsible cone assembly 200 is disposed substantially within the housing assembly 350 within brackets 352/354 when the collapsible cone assembly 200 is in a collapsed state.

In one embodiment of the system for remotely placing visual traffic safety apparatuses, an LED light assembly 240 is disposed on a top or center portion of an LED cone assembly 290 when the cone assembly 200 is respectively in an extended or retracted state. In a related example embodiment, a front and a rear safety cone assembly 200 would be used, coupled to the truck or trailer body. In this example, the width of the safety cone assembly would be about 2.44 meters (M) in length. The chocks used would, for example, have a weight of about 4.1 kilos and would have dimensions of 15.2 cm in height, 24.1 cm in length and 20.3 cm in width, but would not be necessarily limited to such weight or dimensions. The cone assembly 200 and the chock assemblies 500a, 500b and 500c as well as controller 900 would be operable with a 12 volt DC battery.

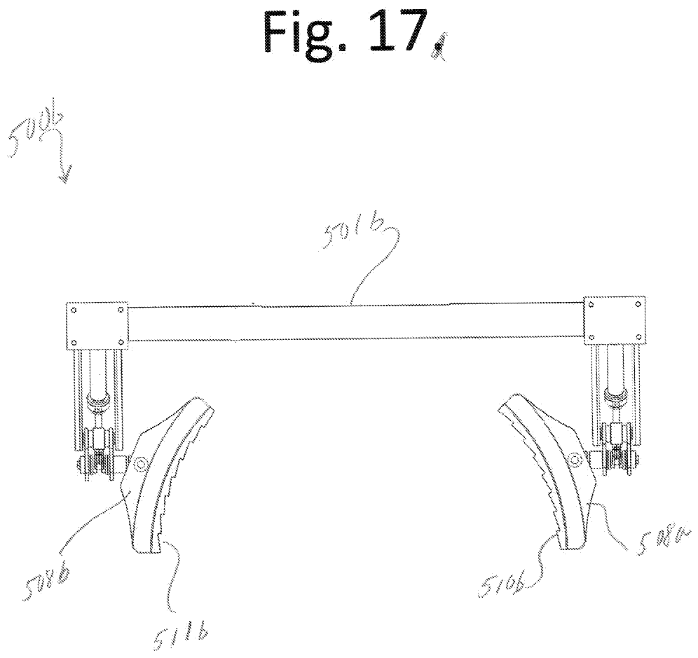

As part of system 100 and as illustrated in FIGS. 9-26 a tire locking or chock system that has at least one inside dual (between 2 tires) chock assembly 500a (see FIGS. 9-16) and an outside semicircular chock assembly 500b (see FIGS. 17-25). In this example embodiment chock assembly 500a and 500b having at least one substantially curved (or semicircular) front face 510a, 510b the at least one front face 510a, 510b designed to substantially contiguously and frictionally couple or be in contact with a treaded surface of at least one vehicle tire member, the chock assembly 500a, and outside chock assembly 500b designed to be in a coupled (affix the vehicle) or uncoupled state (vehicle is free to move).

Referring now specifically to FIGS. 9-16, there is illustrated chock assembly 500a including at least one hydraulically operated frame assembly 600a, 600b is designed to be in a retracted or extended state and is coupled to a mounting plate 503 having mounting screws 503a and 503b and side plates 504a and 504b. At least one hydraulically operated extender assembly 700a is connected by a proximal portion 710a of the at least one extender assembly 700a and to a distal portion 690a of the at least one frame assembly 600b. A distal portion 790a of the at least one extender assembly 700a is coupled to a back face 590a of the at least one chock assembly 500a the at least one extender assembly 700a designed, when in an extended state, to press the front faces 511a and 510a that are located on pad support frame 505 of the at least one chock assembly 500a against the treaded surface of the at least one tire member. At least one chock actuator assembly 502a is electronically or electromechanically coupled to the at least one frame assembly 600a, 600b and at least one chock motor assembly 501a and the at least one extender assembly 700a. In this example embodiment, chock assembly 500a, and/or outside chock assembly 500b, is controlled by at least one controller assembly 900 which is electronically (or wirelessly when chock assembly 500a or 500b include a wireless receiver) coupled to the at least one chock motor assembly 501a and actuated by chock actuator assembly 502a and designed for a user to control the at least one frame assembly 600a, 600b and the at least one extender assembly 700a.

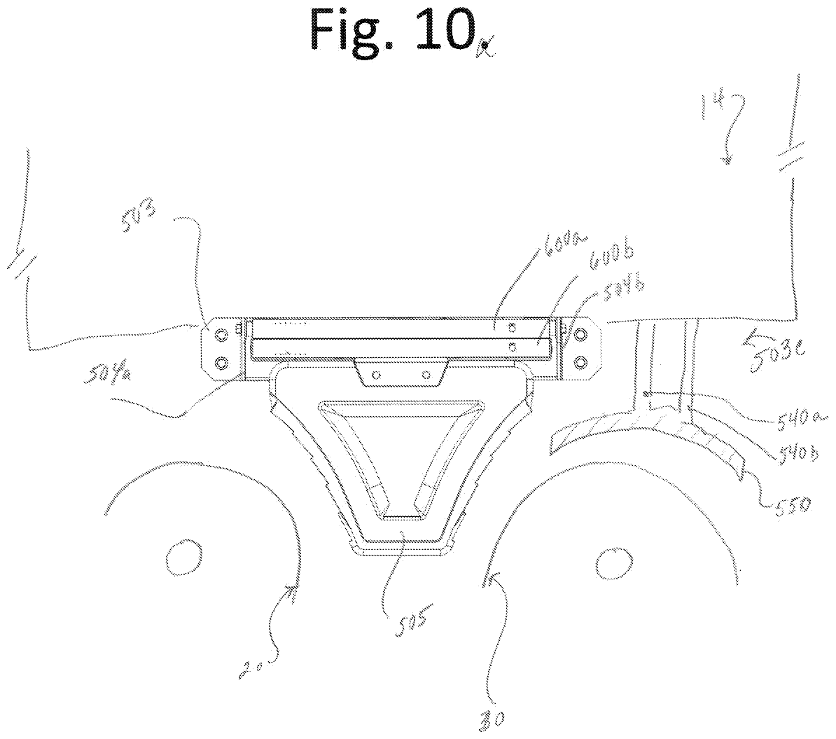

In a related embodiment and referring to FIG. 10, chock assembly 500a can be used solely for a smaller truck having 2 tandem rear wheels 20/30 (typically in the rear to handle heavier loads) or a semi-truck trailer 14 having tandem wheels in front and rear of the trailer to affix the truck or trailer temporarily at a location (for loading/unloading). In a related embodiment, the chock assembly 500a also includes a semi-circular top chock assembly 500c for locating a frictional element 550 on the top of the tire 30 (or the front tire of the trailer of truck cab, whichever is more effective) to help affix its location using one or two pistons 540a/540b (or scissor-like extenders) to lower or raise element 550 onto tire 30 surface. While the vehicle is in motion, element or pad structure 550 is spaced up from the tire about 13.2 centimeters (cm) with pad structure 550 have a length of about 76. 2 cm for a tire having a width of about 22.9 cm. In yet another related embodiment, top chock assembly 500c is used on small trucks and on the rear wheel. Top chock assembly 500c would also operate with the safety cone assembly 200 described above. Referring now to outside chock assembly 500b, and FIGS. 17-25, such includes a support plate 660 for mounting on the truck and uses two pad structures 508b and 508a that support substantially curved front face pads 511b and 510b with the front face pads 510a, 510b designed to substantially contiguously and frictionally couple to a treaded surface of at least one vehicle tire member, the chock assembly 500b designed to be in a coupled or uncouple state. At least two hydraulically operated frame assemblies 670a, 670b are designed to be in a retracted or extended state. At least one hydraulically operated extender assembly 710b, 700b are connected by a proximal portion 672a/672b of the at least one extender assembly 670a, 670b to a distal portion 674a/674b of the at least one frame assembly 690a, 690b. A distal portion 790a, 790b of the at least one extender assembly 710b/700b is coupled to a back face of the at least one chock assembly 590a, 590b the at least one extender assembly 701b, 710b designed, when in an extended state, to press the at least one front face 511b, 510b of the at least one chock assembly 500a, 500b against the treaded surface of the at least one tire member. At least one chock actuator assembly 502a, 502b is electronically coupled to the at least one frame assembly 670a, 670b and at least one chock motor assembly 501a, 501b and the at least one extender assembly 700a, 700b. At least one controller assembly 900 is electronically coupled to the at least one chock actuator assembly 502a, 502b and designed for a user to control the at least one frame assembly 670a, 670b and the at least one extender assembly 701b, 710b.

In one embodiment of the tire locking system, an at least one polymer surface assembly 800a, 800b is coupled contiguously and substantially planarly to the at least one front face of the chock assembly 500a, 500b designed to couple substantially contiguously to the treaded surface of at least one vehicle tire member.

The following patents are incorporated by reference in their entireties: U.S. Pat. Nos. 6,978,865, 9,751,702, and 20190040596A1.

While the inventive concept has been described above in terms of specific embodiments, it is to be understood that the inventive concept is not limited to these disclosed embodiments. Upon reading the teachings of this disclosure, many modifications and other embodiments of the inventive concept will come to mind of those skilled in the art to which this inventive concept pertains, and which are intended to be and are covered by both this disclosure and the appended claims. It is indeed intended that the scope of the inventive concept should be determined by proper interpretation and construction of the appended claims and their legal equivalents, as understood by those of skill in the art relying upon the disclosure in this specification and the attached drawings.

1. A system for remotely placing visual traffic safety apparatuses from a vehicle comprising:
at least one collapsible cone assembly adapted to be in an extended, vertical, and substantially frustoconical form or a collapsed and substantially planar form;
at least one retractable, telescoping rod assembly disposed at least partially within at least one housing assembly, the housing assembly disposed substantially beneath a vehicle, the telescoping rod assembly adapted to be in an extended or retracted state;
at least one foldable, substantially planer, platform assembly coupled to a distal end of the at least one telescoping rod assembly, the platform assembly adapted to be in an unfolded, substantially horizontal state or a folded, substantially vertical state;
the at least one collapsible cone assembly coupled to the platform assembly at, when the platform assembly is viewed in an unfolded state, a top portion of the platform assembly;
at least one rod motor assembly electrically coupled to a rod actuator adapted to extend and retract the rod assembly;
at least one platform motor assembly electrically coupled to a platform actuator adapted to fold and unfold the at least one platform assembly;
at least one cone motor assembly electrically coupled to a cone actuator and adapted to extend or collapse the at least one cone assembly; and
at least one controller assembly electronically coupled to the at least one rod, platform, and cone actuator assemblies adapted for a user to operate the at least one rod, platform, and cone motor assemblies.

2. The system for remotely placing visual traffic safety apparatuses of claim 1 wherein the at least one platform assembly is also a housing assembly with a base portion, a side portion and an open top portion when the platform assembly is in an unfolded and horizontal state, the collapsible cone assembly disposed substantially within the housing assembly when the collapsible cone assembly is in a collapsed state.

3. The system for remotely placing visual traffic safety apparatuses of claim 1 wherein an LED light assembly is disposed on a top or center portion of the cone assembly when the cone assembly is respectively in an extended or retracted state.

4. A tire locking system comprising:
at least one chock assembly, the chock assembly having at least one substantially curved front face, the at least one front face adapted to substantially contiguously and frictionally couple to a treaded surface of at least one vehicle tire member, the chock assembly adapted to be in a coupled or uncouple state;
at least one hydraulically operated frame assembly adapted to be in a retracted or extended state;
at least one hydraulically operated extender assembly connected by a proximal portion of the at least one extender assembly to a distal portion of the at least one frame assembly, and a distal portion of the at least one extender assembly coupled to a back face of the at least one chock assembly, the at least one extender assembly adapted, when in an extended state, to press the at least one front face of the at least one chock assembly against the treaded surface of the at least one tire member;
at least one actuator assembly electronically coupled to the at least one frame assembly and the at least one extender assembly; and
at least one controller assembly electronically coupled to the at least one chock actuator assembly and at least one chock motor assembly and adapted for a user to control the at least one frame assembly and the at least one extender assembly.

5. The tire locking system of claim 4 wherein an at least one polymer surface assembly is coupled contiguously and substantially planarly to the at least one front face of the chock assembly adapted to couple substantially contiguously to the treaded surface of at least one vehicle tire member.
